(19) United States
(12) Patent Application Publication
(10) Pub. No.: US 2025/0134164 A1
(43) Pub. Date: May 1, 2025

(54) A Refilling Station for a Capsule or Cartridge for Electronic Cigarettes

(71) Applicant: JT International SA, Geneva (CH)

(72) Inventor: Alec Wright, Guildford (GB)

(73) Assignee: JT International SA, Geneva (CH)

(21) Appl. No.: 18/693,647

(22) PCT Filed: Sep. 20, 2022
(86) PCT No.: PCT/IB2022/058876

§ 371 Date: Mar. 20, 2024

(30) Foreign Application Priority Data
Sep. 21, 2021 (EP) 21198108.9

(51) Int. Cl. A24F 15/015; A24F 40/10

(52) U.S. Cl. CPC A24F 15/015; A24F 40/10

(57) ABSTRACT

A refilling station for a capsule of a vaping device, includes a receptacle for receiving the capsule, a reading device for reading information from the capsule when the capsule is inserted into the receptacle, a refilling device for injecting e-liquid into a volume of the capsule when the capsule is inserted to the receptacle, a verification system for checking one or more features of the capsule when the capsule is inserted to the receptacle, the one of more features including a state of a heating element of the capsule, and a controller for controlling an operation of the scanning device, the refilling device, and the verification system.

### FIELD OF THE INVENTION

The present invention is directed to the field of refilling systems and devices for refilling capsules or cartridges that contain a dispensable liquid, more particularly a capsules or cartridges that contain

### BACKGROUND

In the field of refilling stations and devices that are used to refill capsules or cartridges with e-liquid, and in the field of inspection systems for the use in electronic cigarettes, vaping devices, and other types of devices for atomizing liquids, and other types of refilling systems for reusable or disposable capsules, cartridges, cannisters, tanks, or containers that contain a dispensable liquid, different solutions have been proposed.

With respect to refilling mechanisms and techniques, for example, United States Patent Publication No. 2015/0336689 discusses a vaping liquid dispensing apparatus 100 that includes nozzle 290 configured to dispense vaping liquids to user container 220, and a measuring pump module 280 configured to pump a measured amount of vaping liquids from the machine container 270 to the nozzle 290, for example by implementing the pump 281 as a syringe pump that is activated by a linear actuator 284.

Moreover, United States Patent Publication Number 2021/0127743 discusses a system 10 that can sort, fill and cap cartridges 20, cannisters and/or other types of containers for e-liquids, in which a needle 308 can be used for filling the cartridge 20, and states that the output needle 308 may be configured with an actuator that may raise and lower the needle 308 so that the output tip of the needle 308 may be placed within the top opening of the cartridge body 30 of the cartridge 20 to dispense the substance into the cartridge 20.

With respect to the performance of different types of automated inspection of different aspects and features of the reusable capsules, cartridges, cannisters, tanks, or containers that contain a dispensable liquid, International Patent Publication Number WO2020/074929 describes a vaping system having a dock 6 that can inspect and refill a refillable pod 11 of a vaping device 10, and mentions the use of a liquid level sensing system using a simple optical systems where a beam of light is sent through a transparent walled liquid reservoir at a point half-way up that reservoir, and if the beam is interrupted in a way that is characteristic of absorption by the type of liquid in the reservoir, then the system assumes that the reservoir is at least half-full with liquid.

Despite all the progress in the field of refilling stations having a refilling mechanism, and automatic inspection and testing systems for refillable or disposable capsules or cartridges, more advanced solutions are desired, to provide for tampering-proof refilling mechanisms for refilling capsules with e-liquid, for inspecting and testing various aspects of the capsules or cartridges, for avoiding counterfeiting, tampering, and quality control and traceability of e-cigarette or vaping products.

### SUMMARY

According to one aspect of the present invention, a refilling station for a capsule or cartridge of a vaping device or other type of electronic cigarette is provided. Preferably, the refilling station incudes a receptacle for receiving the capsule, a reading device for reading information from the capsule when the capsule is inserted into the receptacle, a refilling device for injecting e-liquid into a volume of the capsule when the capsule is inserted to the receptacle, a verification system for checking one or more features of the capsule when the capsule is inserted to the receptacle, the one or more features includes a state of a heating element of the capsule, and a controller for controlling an operation of the scanning device, the refilling device, and the verification system.

According to another aspect of the present invention, a liquid refilling system is provided, for example to refill tanks, containers, capsules, or other liquid-holding volumes with a dispensable liquid. Preferably, the liquid refilling system includes a refilling station and a liquid container, the refilling station can include a receptacle for receiving the liquid container, a refilling device for injecting liquid into a volume of the liquid container when the liquid container is placed in the receptacle, and a controller for controlling an operation the refilling device. Moreover, preferably, the refilling device includes a helix-shaped liquid conduit in fluidic connection with a liquid reservoir, and an actuation assembly configured to provide for a combined rotational and translational movement to introduce and retract the helix-shaped liquid conduit into and from the capsule. In addition, preferably, the liquid container includes a refill port having a tubular helical structure that is complementarily shaped to the helix-shaped liquid conduit.

According to still another aspect of the present invention a refillable capsule (200) of a vaping device (300) is provided. Preferably, the refillable capsule (200) includes a refill port (230) having a tubular helical structure (232) forming a fluidic channel, and a valve (235) arranged to prevent liquid from exiting an volume (240) of refillable capsule (200) via the tubular helical structure (232).

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1A shows a perspective view of a simplified and schematically represented exemplary refill station 100 for a capsule or cartridge 200 that can be used for a vaping device or electronic cigarette 300, also showing a simplified view of vaping device or electronic cigarette 300, and a user U, according to an aspect of the present invention;

FIG. 1B shows a perspective view of a simplified and schematically represented exemplary refill station 100 in the form of a computer connectable docking station for refilling and/or inspecting a capsule or cartridge 200, according to yet another aspect of the present invention;

FIG. 1C shows a cross-sectional view of a simplified view of different elements of an exemplary refill station 100 with a capsule or cartridge 200 removably inserted to the refill station 100, showing aspects of a refilling device 30, a reading device 20 for reading information from the refilling capsule or cartridge 200, and also shows aspects of a verification system 40 for inspecting, measuring, and testing different aspects of the capsule or cartridge 200, according to another aspect of the present invention;

FIG. 2A shows a side and partial cross-sectional view of a simplified refilling device 30 that uses a helical needle or tubular structure 32 for refilling capsule or cartridge 200 with liquid 250, thereby forming a fluidic conduit in a helix-like shape, showing helical needle or tubular structure 32 in an retracted, unconnected position; and

FIG. 2B shows a side and partial cross-sectional view of a simplified refilling device 30 that uses a helical needle or tubular structure 32 for refilling capsule or cartridge 200 with liquid 250, showing helical needle or tubular structure 32 in a connected, expanded position;

FIG. 2C shows a cross-sectional view of elements of the refilling device 30, showing the fluidic connection and passageway for liquid 250 between liquid reservoir 38 and inner volume of capsule or cartridge 200; and

FIG. 3 shows a cross-sectional view of another embodiment of capsule holder 12 and capsule or cartridge 200 having magnets 271, 71 for removable attachment purposes therebetween.

Herein, identical reference numerals are used, where possible, to designate identical elements that are common to the figures. Also, the images are simplified for illustration purposes and may not be depicted to scale.

### DESCRIPTION OF THE SEVERAL EMBODIMENTS

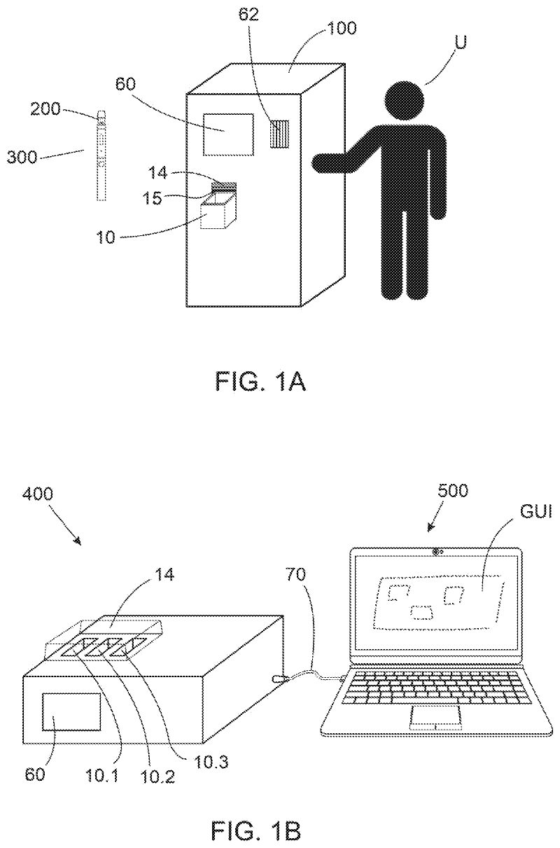

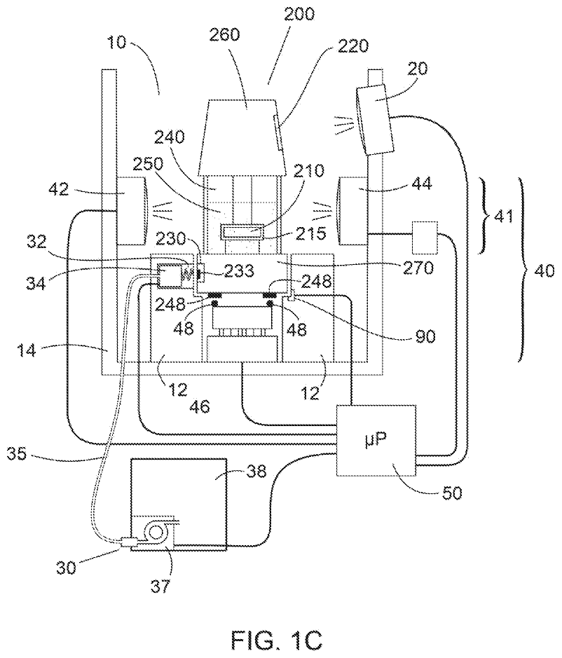

FIG. 1A shows a perspective view of a simplified and schematically represented exemplary refill station 100 for a capsule or cartridge 200 that can be used in conjunction with a vaping device or electronic cigarette 300, also showing a simplified view of vaping device or electronic cigarette 300, and a user U, according to an aspect of the present invention, shown as a vending machine-type device, or other type of automated device that can serve a user U with different services related to an electronic cigarette or vaping device 300. Front face of refill station 100 can include an access opening 15 from which a receptacle 10 can be accessed, for example a motorized receptacle that can egress and retreat from refill station 100 to be partially located outside of refill station 100 by a sliding motion, for example a receptacle 10 that can receive one or more capsules or cartridges 200 with a tray 12, to provide for a user-friendly access to receptacle 10 in an extended, loading position. For example, in the variant shown, receptable 10 is in the form of a drawer that can be automatically egressed to an extended, loading position, and retreated to an inspection and refill position inside a cavity of refill station 100 via access opening 15, FIG to a retreated inspection position. 1A showing receptacle 10 in the extended, loading position. Also, it is possible that access opening 15 can be opened and closed by a door 14, for example a motorized slidable door that allows to close the access opening 15 when receptacle is in the retreated inspection opposition. In a variant, it is also possible that receptacle 10 is located at a fixed position relative to refill station 100, and that there is no door 14 that can cover or otherwise prevent access to receptacle 10. Refill station 100 can also include a display device 60 that can display different types of information, for example information to instruct the user U to use the refilling station 100, for example by the use of a graphical user interface (GUI), and a speaker 62, that can provide for computer-generated spoken instructions to user U on how to use refiling station 100.

In the variant shown, refilling station 100 is shown as a vending machine type device that could be placed outdoors or indoors, for example at areas with high frequency of potential users U. For example, refilling station can be placed in bars, restaurants, train stations, bus stations, metro stations, or other areas where conventionally cigarette vending machines have been placed. However, it is also possible that refilling station 100 is made to be portable, as exemplarily shown in the perspective view of FIG. 1B, for example for portable and personal use, for example as a docking station 400 that can be connected to an electronic data processing device 500, for example but not limited to a desktop computer, portable computer, smartphone, tablet, for example with a data interconnection interface 70, for example but not limited to a wired interconnection via a Universal Serial Bus (USB) port, or with a wireless connectivity capabilities including but not limited to wireless local area network (WLAN), Bluetooth, near field communication (NFC), such that refilling station 100 can be wired or wirelessly interconnected and exchange data with an application software that is operating on the electronic data processing device 500. As shown in FIG. 1B, refilling station 100 includes three (3) receptacles 10.1 to 10.3 for receiving three capsules or cartridges 200, and the openings that are formed by receptacles 10.1 to 10.3 can be covered by a lid or hood 14. In another variant, refilling station 100 is in the form of desktop device, countertop device, or under-the-counter device, or built-in device such as a rack mount, that can be placed or installed at different locations inside a building, for example at a pantry, kitchen, cabinets, office space, bar, or other premises.

In the context of the present specification, a removable capsule or cartridge 200 is described, that can be removably interconnected to an electronic cigarette or vaping device 300, such that capsule or cartridge 200. However, within the context of the embodiments of the present invention, it is also possible that capsule or cartridge 200 that contains the consumable liquid is fixedly connected to electronic cigarette or vaping device 300, for example but not limited to a refillable tank, refillable container, refillable reservoir, refillable cannister. Also, it is possible that the different aspects, techniques, and embodiments of the present invention are not limited to the field of electronic cigarettes and vaping devices, but directed to other types of refilling systems that have refillable liquid containers or reservoirs, for example but not limited to ink cartridges for inkjet printers, scent oil tanks, ink pen cartridges, liquid soap dispensing cartridges, cleaning liquids, liquid adhesives, three-dimensional (3D) printing cartridges.

FIG. 1C shows a cross-sectional view of a simplified representation of the receptacle 10 including representations of different elements of an exemplary refill station 100, 400 with a capsule or cartridge 200 removably inserted to the refill station 100, 400, according to another aspect of the present invention. Receptacle 10 is shown in a cross-sectional view as a drawer-like housing with an open top, having a U-shaped cross-section, for example a drawer that can be egressed and retracted into filling station 100 using a motorized linear sliding mechanism. A capsule holder 12 is arranged inside a cavity formed by receptacle 10, having an openings that are shaped to securely receive capsule or cartridge 200 therein. For example, capsule holder 12 can have an attachment mechanism that is a same or a similar shape, dimensions and mechanism as the attachment mechanism of the electronic cigarette or vaping device 300 for securely receiving capsule 200, for example by the use of a clip-in, snap-lock, complementary receiving docking element, or other type of removable interconnection between capsule 200 and capsule holder 12.

A side view of an exemplary capsule or cartridge 200 is shown, including a reservoir 240 for containing an e-liquid or vaping juice 250, reservoir 240 having transparent walls to allow a user U to view or inspect a fill level of capsule or cartridge 200, having a inhalation side 260 shaped as a mouthpiece having an inhalation opening, having an interconnection side 270 with electrical terminals 248, having a heating element 210 that can formed as a wicking element 215 with electric connections that can be soaked by the e-liquid or vaping juice 250 inside reservoir 240, heating element 210 and electric terminals 248 configured to be electrically connected with each other for providing an electric heating power to wicking element 215. Moreover, different aspects of a verification system 40 are shown, the verification system 40 configured to check one or more features of the capsule 200, when the capsule 200 is inserted or otherwise placed inside the receptacle, preferably placed onto the capsule holder 12.

For example, verification system 40 can include an optical measurement device 41 including a light emitter 42 and a light sensitive receiver 44, for example but not limited to an array of photodiodes or an image sensor or other type of light-sensitive device. Optical measurement device 41 can be operatively interconnected to a data processing device 50, for example but not limited to a microprocessor or microcontroller, that can be part of refill station 100, 400, or can also interconnected to an external data processing device, for example data processing device 500 shown in FIG. 1B, via a corresponding data communication interface. Optical measurement device 41 can be configured such that light-sensitive receiver 44 includes optical and a light sensing surface that can cover a substantial surface or height of the window provided by the transparent walls of reservoir 240, so that different aspects of the reservoir 240 and the contents can be verified. For example, it is possible to detect fill level of reservoir 240 by detecting a top level of the filling, for example by using an edge detection algorithm, detect clarity of liquid 250 to determine whether capsule 200 has been polluted or to see if other types of impurities are present, for example by analyzing a transparency and/or color of liquid 250 with optical measurement device 41. Moreover, optical measurement device 41 can further be configured to capture an image of heating element 210, for example wicking element 215, to inspect wicking element 215 on any quality or issues of use, for example by detecting burnt portions of wicking element 215, detecting particles that are caught up or attached to wicking element 215, and generally perform an image-based inspection of wicking element, to verify for abnormalities, for example aging resulting in color change, disconnected electrical contacts, and other aspects. The inspection can be performed based on images that captured by an image sensor and optics arranged at light-sensitive receiver 44, with or without the backlight provided by light emitter 42. In this respect, it is also possible that light-sensitive receiver 44 is equipped with an illumination device that allows to illuminate portions of capsule 200, for example at least the heating element 210.

Moreover, verification system 40 can further include an electric measurement device 46, for example but not limited to impedance measurement device, resistance measurement device, induction or capacitance measurement device, having two electrical contacts 48 that can be connected to corresponding electrical contacts 248 of capsule 200. Electrical contacts 48 can be spring-loaded contacts that are brought into contact with electrical contacts 248 of capsule 200 upon insertion of capsule 200 into capsule holder 12, or can be contacts that are automatically actuated with a motor device or other type of actuator to be in contact with electrical contacts 248 of capsule 200. In a case electric contacts 248 are wired to provide for electric power to heating device 210, electric measurement device 46 can be configured to measure an impedance value of heating element 240, for example to measure its resistance value in Ohm (02) or inductance in Henry (H), and upon measuring a resistance or inductance value that is outside an acceptable range, a signal can be generated and transmitted to data processing device 50, the signal indicative of a defective or inoperative heating element 240. In case capsule 200 includes a microprocessor or other data communication device having different settings and parameters stored in a memory that is operatively associated to this processor therein, and this processor is in operative connection with electrical contacts 248 with as a communication port, it is possible that electric contacts 48 and verification system 40 are used to read data from processor, or send data to processor, for example to read historic data on use, operation hours, or to send data to change settings of capsule 200.

Moreover, refilling station 100, 400 can further include a reading device 20 that allow to read data or codes from capsule 200. For example, capsule 200 can be equipped with an optically-readable code 220 in the form of a text code, bar code, matrix code, quick read (QR), optical marker code. Reading device 20 can be configured to detect and read the information of code 220, or can be configured to transmit information of code 220 to data processing device 50 for detecting and reading code information of code 220. For example, code 220 can include information on manufacturer of capsule 200, date of manufacturing, authentication information to verify authenticity of capsule 200, Information of code 200 can also be encrypted such that the data will have to be decrypted with one or more keys to extract usable information. Reading device 20 can include an image sensor, illumination, and a lens that is configured to focus an image onto the imaging plane of the image sensor.

Capsule 200 can also be equipped with an optically-readable marker or tracking marker for three-dimensional localization that can be read by reading device 20, for example but not limited to a QR code, or a specific tracking markers such as ARTags or ArUco markers. For example, with the use of QR code or other type of matrix code, not only code information can be read by reading device 20, but also a position of capsule 200 relative to the position of the reading device 20 can be determined. Thereby, reading device 20 can provide for information on a presence of capsule 200, and also provide information on a correct placement of capsule 200 to capsule holder 12. With the use of an optical marker it can be determined whether capsule 200 is present at all, for example if reading device 20 cannot see or detect the optical marker at all, or whether capsule 200 is arranged at a specific location, for example by using a pre-stored desired location data, allowing to determine whether capsule 200 has been properly placed into capsule holder 12. In variant, reading device 20 is a radio-frequency identification (RFID) reader device having an RFID reader antenna, that allows to detect an read an RFID tag 220 that can be placed or otherwise arranged on capsule 200. It is also possible that other near-field communication (NFC) is used to detect another type of NFC tag that can be embodied with code 220.

Also, a separate presence sensor 90 can be arranged to detect presence or absence of a capsule or cartridge 200 at capsule holder 12, for example but not limited to a capacitive or optical detection sensor that is operatively interconnected with data processing device 50. A signal provided by presence sensor 90 can be used to allow initiation of inspection, measuring or refilling of capsule 200, for example with verification system 40, reading device 20, or refilling device 30.

Refilling station 100, 400 can further include a refilling device 30 that is configured to inserted or introduce a fluidic channel into a refill injection port 230 to inject or otherwise provide e-liquid or vaping juice 250 into a volume 240 of capsule 200, when the capsule 200 is inserted or otherwise provided to receptacle 10. Preferably, refilling device 30 includes a helical lumen, helical, spiral, or coil-like hollow tubular structure, or helical needle 32 having a helically-shaped or spirally-shaped hollow interior forming a fluidic conduit or channel to deliver e-liquid or vaping juice 250 to capsule 200 in an inserted position, an actuation assembly 34 for inserting and withdrawing the helical needle or tubular structure 32 into volume 240 of capsule 200, actuation assembly 34 configured to provide for a combined rotative motion around center axis CA of helical needle or tubular structure 32 and linear translational motion along center axis CA of needle 32, a liquid reservoir 38 for storing or holding e-liquid or vaping juice 250, a pumping device 37 for pumping e-liquid 250 from liquid reservoir 38 to the needle 32, for example but not limited to a syringe-type pump that is formed together with liquid reservoir 38, or a peristaltic pump, and a fluidic connection 35 fluidically interconnecting the liquid reservoir 38 with helical needle, lumen, or tubular structure 32 and pump 37 for providing e-liquid or vaping juice 250 to the capsule 200, when helical needle or tubular structure 32 is in an inserted position relative to capsule 250. In addition, to be able to reversibly insert and withdraw helical or helix-like needle or tubular structure 32 into and from the capsule 250, capsule 250 is equipped with an liquid refill port 230.

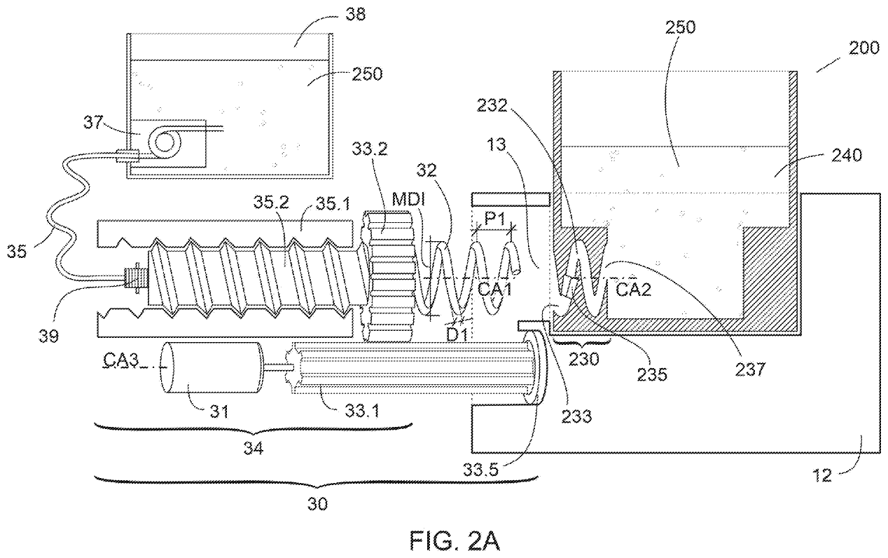

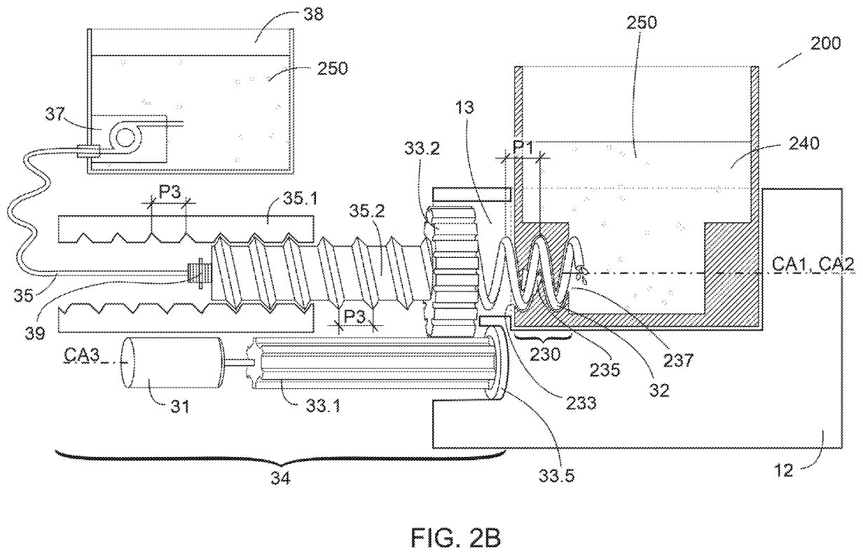

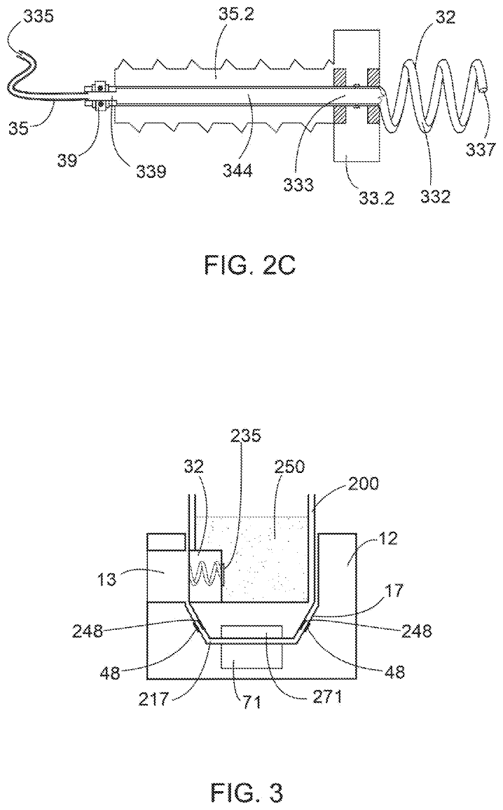

FIGS. 2A and 2B shows a side partially cross-sectional view of aspects of the refilling device 30 and the liquid refill port 230 of capsule 200. Helical needle or tubular structure 32 that is shown in a side view in a retracted position in FIG. 2A, and shown in an inserted position in FIG. 2B, can be used for refilling capsule 200, has a helix or coil-like shape and is configured to have a defined pitch P1, defined diameter D1 of helix that forms helical needle or tubular structure 32, defined mean diameter MD1, and a defined coil angle α1 that is such that it can be rotatively inserted to a corresponding hollow helical structure 232 of a liquid refill port 230, helical structure 232 having the same pitch P2 equal P1, the same mean diameter MD2 equal MD1 and the same coil angle α2 equal to α1, having an inner diameter of tubular structure that is somewhat larger than diameter D1 to accommodate helical needle or tubular structure 32 therein. Hollow helical structure 232 forms a helical injection path or fluidic channel for injecting liquid 250 to volume 240. Also, liquid refill port 230 can include a valve 235 that is configured to be penetrated or otherwise traversed by helical needle or tubular structure 32 for liquid passage, as shown in FIG. 2B, and closing off the connection from inlet 233 to outlet 237 of helical structure 232 when helical needle or tubular structure 32 is retracted, as shown in FIG. 2A. Outlet 237 of helical structure 232 of port 230 provides for a fluidic interconnection to an inner volume 240 of capsule 200, or can also be traversed by helical needle or tubular structure 32 once in a fully inserted position, so that liquid 250 can be directly injected to inner volume 240 of capsule 200. In a variant, valve 235 can be such that it is not traversed by helical needle or tubular structure 32, but is arranged at the outlet side of helical structure 232, and is opened based on a fluidic pressure that is departed by pump 37 to liquid 250, provided from reservoir or tank 38 to helical needle or tubular structure 32. For example, such valve 235 can be implanted as a silicon seal or flexible flap as shown in FIG. 3, or a solenoid valve that opens upon a given pressure, similar to a relief valve.

As shown in FIGS. 2A and 2B in a schematic, simplified fashion, when capsule 200 is inserted and fastened to holder 12, the orientation and position of capsule 200 and thereby helical structure 232 of liquid refill port 230 is at a defined position relative to helical needle or tubular structure 32 of refilling device 30, such that center axis CA1 of helical needle or tubular structure 32 coincides with center axis CA2 of helical structure 232 of port 230, and in addition, a pitch P1 of tubular structure or needle 32 is matching correspondence with pitch P2 of helical structure 232. Thereby, actuation assembly 34 can drive tubular structure or needle 32 into the corresponding helical structure 232 of liquid refill port 230, by a combined rotational and linear translational movement that is imparted to needle 32. Moreover, inlet 233 of helical structure 232 can have a tapered or conical shape, having a wider diameter at the wall of capsule 200 as compared to the remaining part of tubular structure 232, to allow for an easier introduction of helical needle 32 into helical structure 232 upon a slight misalignment of axes CA1, CA2, for example due to imperfect manufacturing tolerances of capsule 200.

Thereby, a method can be performed according to an aspect of the present invention, where in a first step, a presence and correct placement of capsule 200 can be detected by reading device 20, presence sensor 90, or both, upon detection of a correct placement and presence, a step can be performed where helical needle or tubular structure 32 is inserted into helical structure 232 to bypass valve 235 where needle 32 traverses valve 325, thereafter, a step can be performed where e-liquid 250 is provided from reservoir 38 with a pumping action by pump 37 into inner volume 240 via inlet 237 of refill port 230, to fully or partially refill capsule 220, and a step can be performed where a fill level is detected to monitor the filling step by the use of verification system 40, and a step can be performed where helical structure or needle 32 is fully retracted from refill port 230, thereby closing valve 235. This sequence of steps can be controlled by data processing device 50, that is in operative connection with pump 37, actuation assembly 34, verification system 40, reading device 20, and presence sensor 90. The advancing and retracting of helical needle or tubular structure 32 can be done by a drive mechanism 34 that allows to depart the combined rotational and translational movement to helical needle or tubular structure 32.

For example, drive mechanism 34 can include a motor 31 that can be configured to rotate clockwise and counterclockwise of advancing and retracting helical needle or tubular structure 32, motor 31 interconnected to a gearwheel bolt 33.1, and configured to rotate gearwheel bolt 33.1 in both rotational directions, a gearwheel 33.2 that is engaging with gearwheel bolt 33.1, a helical needle or tubular structure 32 having a hollow and helix- or coil-like inner fluidic channel, a hollow threaded drive shaft 35.2 having an outer threading that is threadably engaged with a threaded drive cylinder 35.1 having a corresponding inner threading, both arranged concentrically to central axis CA1, a fluidic flexible tube 35 that provides for a fluidic interconnection between reservoir 38 and helical needle or tubular structure 32, for example via hollow threaded drive shaft 35.2 and rotatable fluid coupling 39. Moreover, rotational axis CA3 of motor 31 is arranged to be in parallel with central axis CA1. Pump 37 is configured to pressurize liquid 250 into fluidic flexible tube 35 and into helical needle or tubular structure 32 for delivering liquid 250 to inner volume 240, when helical needle or tubular structure 32 is in an inserted position. The threading of threaded drive shaft 35.2 and threaded drive cylinder 35.1 are such that they have the same pitch P3 as pitch P1 of helical needle or tubular structure 32 and pitch P2 of tubular structure 232, and also are arranged such that all three pitches P1, P2, and P3 are matching or in synchronization with each other. One side of gearwheel bolt 33.1 can be rotatively attached to capsule holder 12, for example with a rotative ball bearing 33.5, and the other side can be attached to motor 31. Different variants and embodiments to drive mechanism 34 and corresponding gearings are possible, as long as a precise combined rotational and linear translational movement can be departed to helical needle or tubular structure 32. In a variant of drive mechanism 34, motor 31 can or indirectly drive threaded drive shaft 35.2 in axis with central axis CA1. Also, in the variant shown, refill port 230 and central axis CA2 thereof are shown to be arranged to be at a side wall of capsule 200, but it is also possible that refill port 230 is arranged at a bottom wall of capsule 200, or at other locations, for example with central axis CA1 arranged perpendicularly to the illustrated central axis CA1.

With such arrangement, as the rotation and linear translation of helical needle or tubular structure 32 is mechanically linked to rotation and linear translation of threaded drive shaft 35.2 and threaded drive cylinder 35.1, such that upon departing a rotation to threaded drive shaft 35.2 in clockwise or counterclockwise direction, helical needle or tubular structure 32 can rotate and linearly translate along axis CA1, for example to be introduced or retracted from helical hollow structure of port 230. Drive mechanism 34 is thereby configured such that a three-hundred and sixty (360°) degrees rotation or one full rotation to threaded drive shaft 35.2 around axis CA1 will depart a linear translational movement to threaded drive shaft 35.2 and helical needle or tubular structure 32 by the length of pitch P1, P2. To improve precision of the rotational and translational guidance provided by threaded hollow drive shaft 35.2 and threaded drive cylinder 35.1, these elements can be embodied as a ball screw. Rotation to gearwheel 33.2 that is in operative and mechanical connection with threaded drive shaft 35.2, helical needle or tubular structure 32, or both can be done by made by gearwheel bolt 33.1 that is rotated by motor 31, and gearwheel bolt 33.1 extends along axis CA3 such that gearwheel 33.2 can move linearly relative to axis CA3 while rotating, to allow for the linear progression of needle 32 towards and into port 230, due to the matching and synced pitch positions of pitch P1 and pitch P2. Motor 31 can be connected to a motor drive electronics, and motor drive electronics in turn can be operatively interconnected to data processor 50 for control, as schematically illustrated in FIG. 1C. Moreover, a rotatable liquid coupling 39 or other type of rotatable fluid interface can be provided between liquid tube 35 and inner hollow structure of threaded drive shaft 35.2, allowing for hollow threaded drive shaft 35.2 to rotate, for example but not limited to a rotary union or swivel, while liquid tube 35 remains stationary.

FIG. 2C shows an exemplary cross-sectional view of flexible tube 35, rotatable liquid coupling 39, threaded hollow drive shaft 35.2, helical needle or tubular structure 32 with base or holding element 33.2 of the refilling device 30, to show the fluidic connection from fluidic flexible tube 35 to egress opening 337 of helical needle or tubular structure 32. For example, a rotatable liquid coupling 39 can be arranged at a proximal end of threaded hollow drive shaft 35.2, arranged to rotate in axis with a rotational axis CA1, providing for a fluidic interconnection between flexible tube 35 and an inner hollow channel or duct 344 inside threaded hollow drive shaft 35.2. Moreover, gearwheel 33.2 is shown with an inner structure providing for a fluidic interconnection between hollow channel or duct 344 of threaded hollow drive shaft 35.2, and helical- or coil-like channel 332 of helical needle or tubular structure 32 with a seal 339.

FIG. 3 shows a cross-sectional view of another embodiment, showing capsule or cartridge 200 that is placed in connection with a capsule holder 12, where a floor of receiving opening of capsule holder 12 includes a magnet 71, and a lower area of capsule or cartridge 200 includes a magnet 271 having an opposite polarity, to provide for an additional holding force to keep capsule or cartridge 200 in a precisely defined geometric relationship for the refilling, more specifically for the introduction of helical needle 32 into refill port 230. In addition, to provide for an accurate positioning of capsule or cartridge 200 relative to capsule holder 12, a portion of an outer surface of capsule or cartridge 200 can be made complementary to a corresponding surface of receiving opening of capsule holder 12, for example but not limited to the use of corresponding grooves and ridges, corresponding protrusions and indentations. For example, parts of side walls of receiving opening of capsule holder 12 can be conically shaped, whereas pars of the side walls of capsule or cartridge 200 have a complementary conical shape for secure and precise placement. It is also possible that magnet 71 of capsule holder 12 is an electromagnet that can be powered and magnetized with an electric coil winding only once capsule or cartridge 200 is placed into capsule holder 12, for example by detection with presence sensor 90 and by use of data processing device 50, or by detection with reading device 20, while element 271 is a ferromagnetic element.

Also, the specific type of capsule or cartridge 200 shown in FIG. 1C or in FIG. 3 is provided for illustration and explanatory purposes, and many other types of liquid-containing devices can be interconnected to refilling station 100, for refilling and inspection purposes, for example different types of tanks, reservoirs, containers, and other liquid-holding volumes, but also electronic cigarettes or vaping devices themselves where the liquid-holding volume is not removable from the electronic cigarette or vaping device, so that the electronic cigarette or vaping device can be placed inside receptacle 10, for example to a holder 12, for refilling and inspection purposes.

With the provision of a liquid port 230 at capsule 200 that has a helically-shaped liquid conduit or channel for refilling purposes, it is possible to provide for a refilling mechanism or device 30, for example the one shown in FIGS. 2A and 2B, that is difficult to tamper with or to bypass by using homemade devices. Specifically, from the outside of capsule 200, it would be difficult for a potential tamperer or otherwise unauthorized individual who wants to refill a capsule 200 to identify the type of liquid port 230, as only the opening inlet 233 can be seen. A pitch P2 and mean diameter MD2 of liquid port 230 and coil angle α2 can be kept secret and cannot be identified or determined by inspecting capsule 200 from the outside. In this respect, such capsule 200 cannot be refilled by using a classical syringe with a needle.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments, and be given the broadest reasonable interpretation in accordance with the language of the appended claims.

1. A refilling station for a capsule of a vaping device, comprising:
a receptacle for receiving the capsule;
a reading device for reading information from the capsule when the capsule is inserted into the receptacle;
a refilling device for injecting e-liquid into a volume of the capsule when the capsule is inserted into the receptacle;
a verification system for checking one or more features of the capsule when the capsule is inserted into the receptacle, the one or more features includes a state of a heating element of the capsule; and
a controller for controlling an operation of the reading device, the refilling device, and the verification system.

2. The refilling station according to claim 1, wherein the verification system includes an optical inspection device including a camera having an image sensor.

3. The refilling station according to claim 2, wherein the one or more features checked by the optical inspection device includes a fill level of a reservoir of the capsule.

4. The refilling station according to claim 1, wherein the verification system includes an electric measurement device, and the one or more features includes an electric characteristic of a heating element of the capsule.

5. The refilling station according to claim 1, wherein the reading device includes an optical reader for reading information from a code from the capsule.

6. The refilling station according to claim 5, wherein the code includes at least one of a barcode, a matrix code, a QR code, and or an optical marker.

7. The refilling station according to claim 1, wherein the reading device includes a RFID reader for reading information from an RFID tag of the capsule that includes the information.

8. The refilling station according to claim 1, wherein the refilling device includes a helical needle in fluidic connection with a liquid reservoir, and an actuation assembly configured to introduce and retract the helical needle via a port into and from the capsule.

9. The refilling station according to claim 1, wherein the receptacle includes a tray and a capsule holder.

10. The refilling station according to claim 9, wherein the capsule holder is configured to hold the capsule such that the capsule has a defined position relative to the refilling device.

11. The refilling station according to claim 1, wherein the refilling device includes a motor and a gearing configured to apply a translational movement and a rotational movement to the helical needle.

12. The refilling station according to claim 8, wherein the refilling device includes a fluidic duct providing for a fluidic connection between the liquid reservoir and the helical needle, and a rotatable fluidic interconnection element.

13. The refilling station according to claim 1, wherein the state of the heating element includes a quality issue of the heating element including at least one of burnt portions of the heating element, particles that are caught up or attached to the heating element, color change of the heating element, or disconnection of electrical contacts of the heating element.

14. A liquid refilling system comprising a refilling station and a liquid container, the refilling station including,
a receptacle for receiving the liquid container,
a refilling device for injecting liquid into a volume of the liquid container when the liquid container is placed in the receptacle, and
a controller for controlling an operation the refilling device,
wherein the refilling device includes,
a helix-shaped liquid conduit in fluidic connection with a liquid reservoir, and
an actuation assembly configured to provide for a combined rotational and translational movement to introduce and retract the helix-shaped liquid conduit into and from the liquid container,
wherein the liquid container includes,
a refill port having a tubular helical structure that is complementarily shaped to the helix-shaped liquid conduit.

15. The liquid refilling system of claim 14, wherein the refill port of the liquid container includes a valve that is configured to be traversed by the helix-shaped liquid conduit.

16. A refillable capsule of a vaping device, comprising:
a refill port having a tubular helical structure, and
a valve arranged to prevent liquid from exiting a volume of the refillable capsule via the tubular helical structure.

17. The refillable capsule of claim 16, wherein the valve is configured to be traversed by a helix-shaped liquid conduit that is introduced to tubular helical structure.

18. The refillable capsule of claim 16, wherein the valve is configured to open at a given liquid pressure inside the helix-shaped liquid conduit such the liquid can be provided via the helix-shaped liquid conduit to the volume.
